(19) United States
(12) Patent Application Publication
(10) Pub. No.: US 2007/0265919 A1
(43) Pub. Date: Nov. 15, 2007

(54) SYSTEMS AND METHODS FOR ONLINE ADVERTISING

(76) Inventor: Antoine Jarjour, Everett, WA (US)

Correspondence Address: RUTTLER LAW LLC, 1122 EAST PIKE STREET, # 1131, SEATTLE, WA, 98122, US

(21) Appl. No.: 11/746,622

(22) Filed: May 9, 2007

Related U.S. Application Data
(60) Provisional application No. 60/747,078, filed on May 11, 2006.
(60) Provisional application No. 60/821,652, filed on Aug. 7, 2006.
(60) Provisional application No. 60/829,108, filed on Oct. 11, 2006.

(51) Int. Cl. G06Q 30/00

(52) U.S. Cl. 705/14

(57) ABSTRACT

This invention relates generally to online advertising, and more specifically, to systems and methods for sharing online advertising revenue with consumers based on a ranking. In one embodiment, the invention includes a method of advertising online, the method including the steps of establishing a website; accepting an advertiser, the advertiser having an advertisement; posting the advertisement on the website; awarding points to at least one consumer for interacting with the advertisement; tracking the awarded points for each of the at least one consumer; ranking the awarded points for each of the at least one consumer; compensating at least one of the at least one consumer based on the ranking. In one particular embodiment, the interacting includes any of viewing, clicking, and purchasing through the advertisement. In yet another particular embodiment, the compensating based on the ranking includes awarding value to the at least one consumer.

### PRIORITY CLAIM

This application claims the benefit of U.S. Provisional Application No. 60/747,078 filed May 11, 2006; U.S. Provisional Application No. 60/821,652 filed Aug. 7, 2006; and U.S. Provisional Application No. 60/829,108 filed Oct. 11, 2006. The foregoing applications are incorporated by reference in their entirety as if fully set forth herein.

### FIELD OF THE INVENTION

This invention relates generally to online advertising, and more specifically, to systems and methods for sharing online advertising revenue with consumers based on a ranking.

### BACKGROUND OF THE INVENTION

The purpose of advertising is simply to promote a product or service in the marketplace. Prior to the internet, advertising was primarily conducted in the form of television commercials, newspapers, or magazines. The means for advertising were fairly limited and well defined and were, therefore, highly effective in reaching consumers.

The advent of the internet provided advertisers another channel and many more opportunities to market their wares. Similarly to advertising on television, newspapers, or magazines, advertisers could place solicitations on websites so that visitors to the websites would become familiar with the advertiser's product or services. However, because websites were fairly easy and inexpensive to set up, their numbers quickly proliferated into the millions. This proliferation, combined with the ease of advertising on the websites, made it difficult to effectively reach consumers. Indeed, consumers were inundated with online advertising at every corner of the internet and as a result were becoming desensitized to online solicitations.

Over time, online advertising channels have become more defined and centralized, thereby improving on some of the past problems of internet advertising. Furthermore, certain inventions have been devised to address the desensitization and to increase consumer participation in viewing online advertisements. For instance, online advertisements have been programmed to be more intelligent and interactive whereby they are displayed at times and places where they are most likely to be viewed. One particular invention has gone so far as to directly compensate consumers each time they view certain advertisements. Thus, with this invention every time a consumer clicks on an advertisement they are immediately rewarded with cash or credits that are redeemable for goods or services. Needless to say, this invention is very expensive to implement and invites fraudulent behavior. Other inventions donate dollars to a charity of a consumer's choice merely for viewing an online advertisement. These inventions don't provide the incentive levels present with cash or credit rewards.

Therefore, although desirable results have been achieved, there exists much room for improvement. What are needed then, are systems and methods for online advertising.

### SUMMARY OF THE INVENTION

This invention relates generally to online advertising, and more specifically, to systems and methods for sharing online advertising revenue with consumers based on a ranking. In one embodiment, the invention includes a method of advertising online, the method including the steps of establishing a website; accepting an advertiser, the advertiser having an advertisement; posting the advertisement on the website; awarding points to at least one consumer for interacting with the advertisement; tracking the awarded points for each of the at least one consumer; ranking the awarded points for each of the at least one consumer; compensating at least one of the at least one consumer based on the ranking. In one particular embodiment, the interacting includes any of viewing, clicking, and purchasing through the advertisement. In yet another particular embodiment, the compensating based on the ranking includes awarding value to the at least one consumer.

### BRIEF DESCRIPTION OF THE DRAWINGS

Embodiments of the present invention are described in detail below with reference to the following drawings:

FIG. 1 is a block diagram of a method for sharing advertising revenue with consumers based on a ranking, in accordance with an embodiment of the invention; and

FIG. 2 is a system for sharing advertising revenue with consumers based on a ranking, in accordance with an embodiment of the invention.

### DETAILED DESCRIPTION

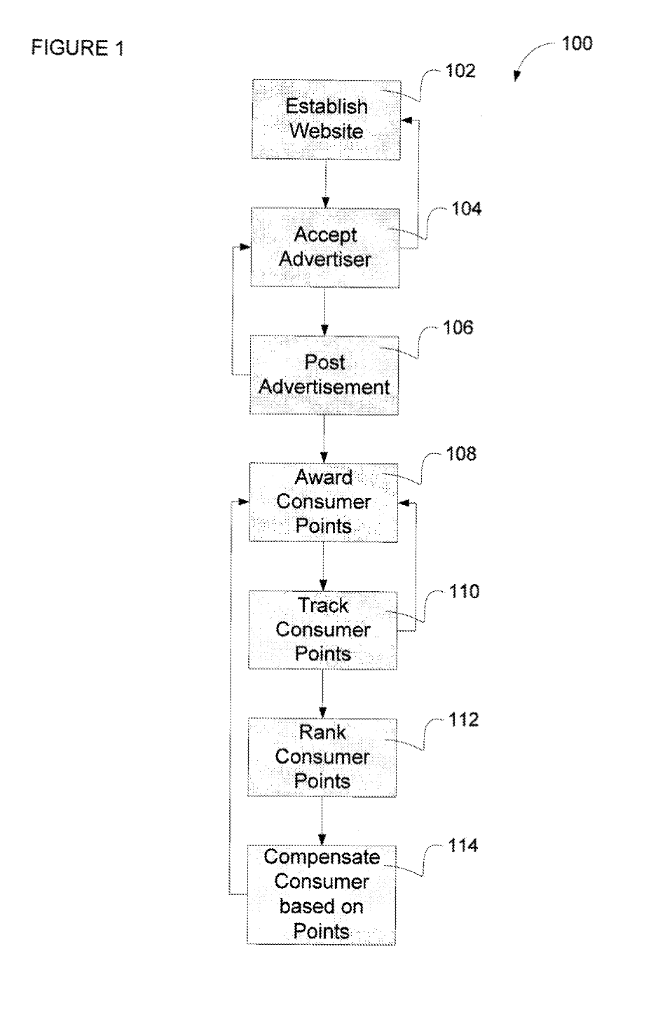

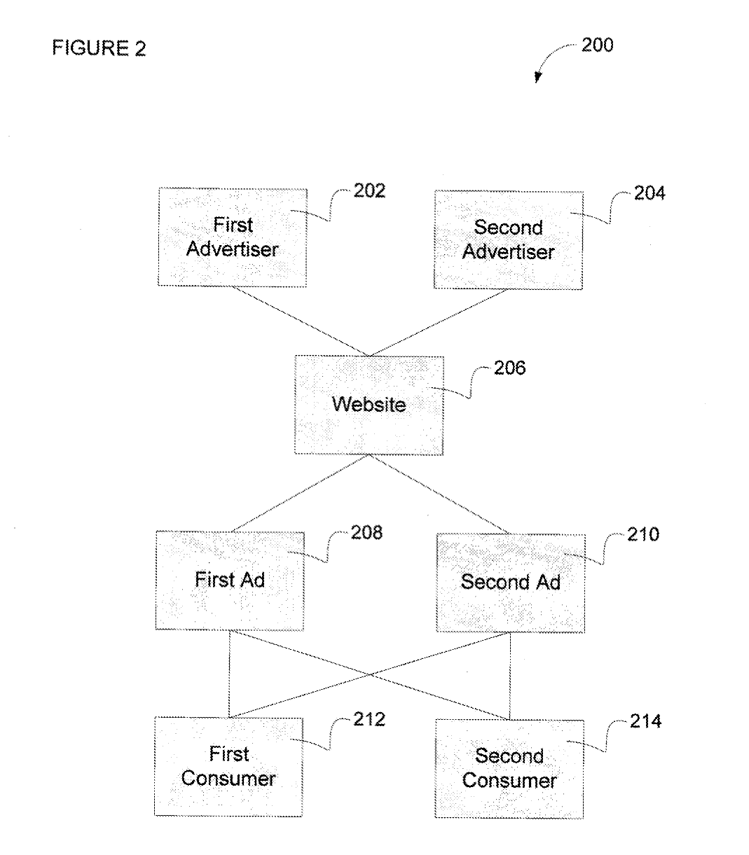

This invention relates generally to online advertising, and more specifically, to systems and methods for sharing online advertising revenue with consumers based on a ranking. Specific details of certain embodiments of the invention are set forth in the following description and in FIGS. 1-2 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a method for sharing advertising revenue with consumers based on a ranking, in accordance with an embodiment of the invention. In one embodiment, method 100 includes establishing a website at block 102, accepting an advertiser at block 104, posting an advertisement on the website at block 106, awarding a consumer points at block 108, tracking the consumer points at block 110, ranking the consumer points at block 112, and compensating the consumer based on the points at block 114.

In one particular embodiment, the establishing a website at block 102 includes configuring a website to be accessible over the internet. In certain embodiments, the website is dedicated to advertising, whereas in others it is combined with other functionality such as providing information, selling goods, offering services, or searching. The website may be independently owned and operated, a partnership website, or a combination of the two. The website is accessible via any display medium such as a personal computer, mobile phone, or personal digital assistant. The website may include a plurality of pages.

In another embodiment, the accepting an advertiser at block 104 includes forming an agreement with an advertiser to place its advertisement on the website. The agreement may include a fee for placing the advertisement on the website, which may vary based on duration, number of impressions, number of clicks, number of sales, location on the website, or any other similar factor. The advertiser is any of a seller of goods or services, educator, or any other entity that desires to provide information or solicit consumers. In certain embodiments, the method 100 may return to block 102 whereby additional advertisers are accepted.

In yet another embodiment, the posting an advertisement at block 106 includes placing the advertisement on the website in accordance with the agreement. In certain embodiments, the method 100 may return to block 104 whereby additional advertisements may be accepted for the same advertiser or an additional advertiser.

In a further embodiment, the awarding a consumer points at block 108 includes providing a point to a consumer when the consumer interacts with the advertisement on the website. The interaction may include viewing, clicking, or purchasing through the advertisement. Different numbers of points may be awarded for different interactions. For instance, the consumer may be awarded a given number of points merely for viewing the advertisement, another number of points for clicking the advertisement, and another amount of points for purchasing goods or services through the advertisement. Accordingly, the consumer may decide to make the website her homepage and may be awarded points for merely opening her browser. The consumer may optionally elect to be awarded more points by clicking an advertisement and yet even more points by purchasing through an advertisement. Points may be awarded for other reasons including for merely bonus reasons or for diving down to sub-pages within the website. In one particular embodiment, points may be awarded to a consumer for the consumer recommending the website to first individual, for the first individual recommending the website to a second individual, or for the second individual recommending the website to a third individual. Points may be further awarded to the consumer for interactions by the first, second, or third individuals. In certain embodiments, points may differ based on the location of the advertisement on the website or the depth of the advertisement within pages of the website. In certain embodiments, where there are multiple advertisers or multiple advertisements, points may be awarded differently based on the advertisement or the advertiser. For instance a greater number of points may be awarded for a consumer purchasing an automobile through an advertisement than from purchasing sporting event tickets. Further, a greater number of points may be awarded for one brand of car than another brand of car. The points may have no cash value, may represent cash value, may be exchangeable with partners for cash or other points such as airline points, or may be redeemable for goods, services, or discounts from the advertiser or any other entity.

In one particular embodiment, a consumer can elect for advertisements to be sent to his or her email account. Thus, instead of requiring the consumer to actively visit the website, the consumer can passively receive advertisements through an email account. The advertisements may be general in nature or may optionally be narrowed to specific categories of goods, target age ranges, prices, number of advertisements, time periods, or other useful refinement. The advertisements may be present on the website or may be different from or in addition to those advertisements posted on the website. In one embodiment, the consumer can elect on the fly to not receive advertisements from a particular source. The consumer is awarded points similar to the manner discussed supra. For instance, the consumer may be awarded points for receiving the advertisements, clicking on the advertisements, purchasing through the advertisements, or forwarding the advertisement on to additional consumers. In one particular embodiment, the email account embodiment is practiced separately and independently from the website.

In another particular embodiment, a consumer can elect for hard copy advertisements to be sent to his or her physical mail box. Thus, instead of requiring the consumer to actively visit the website or view advertisements through an email account, the consumer can optionally passively receive advertisements through a physical mail box. The advertisements may be general in nature or may optionally be narrowed to specific categories of goods, target age ranges, prices, number of advertisements, time periods, or other useful refinement. The advertisements may be present on the website or may be different from or in addition to those advertisements posted on the website. In one embodiment, the consumer can elect not receive advertisements from a particular source. The consumer is awarded points similar to the manner discussed supra. For instance, the consumer may be awarded points for receiving the advertisements, visiting the website and clicking on the advertisements, calling or emailing regarding the advertisement, or purchasing from the advertisements. In one particular embodiment, the mail box embodiment is practiced separately and independently from the website or the email account embodiment.

In yet another embodiment, an advertiser that traditionally has sent advertisements in hard copy to physical mail boxes of a consumer can alternatively send the advertisements electronically to the consumer via electronic mail. In this embodiment, the consumer's physical mail box address is associated with the consumer's electronic mail account. Accordingly, the advertiser can reach the consumer either by physical mail or by electronic mail, thereby saving resources such as the cost of printing and postage. The consumer is awarded points similar to the manner discussed supra. For instance, the consumer may be awarded points for receiving the advertisements, clicking on the advertisements, inquiring regarding the advertisements, or purchasing from the advertisements. In one particular embodiment, the physical mail box/electronic email embodiment is practiced separately and independently from the website.

In yet a further embodiment, the tracking consumer points at block 110 includes aggregating the points awarded to the consumer for any interaction or other reason. In certain embodiments, the consumer establishes an account on the website and logs into the account prior to interacting with an advertisement; the login process may be automatic. This provides a methodology to track the consumer points based on the account; however, alternative means may be employed such as using cookies or unique IP addresses. The tracking may take place over time and for various interactions with various advertisements at different locations on the website, email, or physical mail box. Indeed, the tracking may also take place over multiple partner websites. Accordingly, a consumer may make the website her homepage, view a given advertisement, click on another advertisement, purchase from yet another advertisement, and refer a friend all over the course of an extended time period. The points awarded to the consumer for each of these interactions or reasons would be tracked. Thus, in certain embodiments, the method 100 may return to block 108.

In another embodiment, the ranking consumer points at block 112 includes comparing the tracked number of points for a plurality of consumers at a given time. A consumer with a greater number of tracked points is ranked higher than another consumer with fewer tracked points. Each of the plurality of consumers is ranked in a similar fashion. In certain embodiments, the ranking is held in confidence and not revealed to the plurality of consumers until the given time. This methodology assists in avoiding loss of consumer motivation to interact with an advertisement prior to the given time as would likely occur if a consumer knew that there was no hope for being ranked as desired.

In yet another embodiment, the compensating consumers based on points at block 114 includes determining which consumers have a rank above a given percentile and awarding cash or other value to those consumers. For instance, in certain embodiments consumers having a rank in the top 20% may be awarded a certain amount of cash. The cash in certain embodiments sources from the advertisers. The cash from the advertisers in these embodiments may be invested prior to being distributed to the consumers as compensation. Alternatively, the consumers having a certain rank, such as first or second may be awarded more cash or value. Other compensation may be awarded for other achievements such as most number of referrals, most points by referrals, most impressions, or other similar achievement. Rankings may also be grouped into different tiers and cash or other value may be awarded to consumers based on their membership in a tier. In one particular embodiment, the consumers who are compensated have their tracked points zeroed out whereas the consumers who are not compensated are permitted to keep their tracked points for future purposes. In one particular embodiment, the value awarded to consumers includes any of a stock, an option, a bond, a futures contract, a savings account, a money market account, a certificate of deposit, or any other financial interest in a company, a debtor, or a commodity. In certain embodiments, the financial interest is held and marketable at a partner brokerage. In other embodiments, any capital gains or interest earned from the financial interest can be redeemable from an advertiser at the website to accumulate additional points. In yet another particular embodiment, the value awarded to consumers is in the form of a debit card that can be used at any store that accepts debit or credit cards. In one particular embodiment, the value awarded to consumers is in the form of a stock in a company. The company may be the same company implementing the method 100, a subsidiary company, or an unrelated company. In a further particular embodiment, the company is in the business of mining natural resources. In certain embodiments, the natural resources may include, but are not limited to, any of gold, silver, diamonds, oil, salt, coal, rubies, sapphires, copper, or water. Accordingly, in one particular embodiment, consumers are awarded stock in a gold-mining company that is a subsidiary of the company implementing the method 100. The stock is worth a nominal amount when the subsidiary company has not yet discovered gold; however, the stock may increase in value once the subsidiary discovers gold. Thus, consumers, even those that have a very low rank, are able to be awarded value that is nominal, but has the potential of being very significant. The method 100 may optionally return to block 108.

FIG. 2 is a system for sharing advertising revenue with consumers based on a ranking, in accordance with an embodiment of the invention. In one embodiment, system 200 includes a first advertiser 202, a second advertiser 204, a website 206, a first ad 208, a second ad 210, a first consumer 212, and a second consumer 214.

In one embodiment, the website 206 is a web page or collection of web pages accessible via the internet. The website 206 may be dedicated to advertising, dedicated to providing information, dedicated to selling or buying, or a combination thereof. The first advertiser 202 places the first ad 208 on the website 206. The first ad 208 is accessible to the first consumer 212. In certain embodiments, there may be additional consumers, such as the second consumer 214, and the first ad 208 would be accessible to the additional consumers. The first ad 208 is accessible through any of viewing, clicking, and purchasing through. In one particular embodiment, the system 200 further includes additional advertisers, such as the second advertiser 204, who may place additional ads, such as the second ad 210 on the website 206 for consumers such as the first and second consumer 212, 214 to access.

In one particular embodiment, the system 200 implements one or more of the embodiments discussed in reference to FIG. 1. Accordingly, any of the first and second consumer 212, 214 are awarded points for interacting with any of the first and second ad 208, 210. The interaction may include viewing, clicking, or purchasing through the first and second ad 208, 210. The points are tracked over time and at the end of a given period the tracked points for each of the first and second consumer 212, 214 are compared. The higher ranked consumer is compensated, while the lesser ranked consumer may not be compensated as much or at all. The given period may then be reset whereby the steps are repeated.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method of advertising online, the method comprising the steps of:
establishing a website;
accepting an advertiser, the advertiser having an advertisement;
posting the advertisement on the website;
awarding points to at least one consumer for interacting with the advertisement;
tracking the awarded points for each of the at least one consumer;
ranking the awarded points for each of the at least one consumer;
compensating at least one of the at least one consumer based on the ranking.

2. The method of claim 1, wherein the interacting includes any of viewing, clicking, and purchasing through the advertisement.

3. The method of claim 1, further comprising awarding points to the at least one consumer for recommending the website to another individual.

4. The method of claim 3, further comprising awarding points to the at least one consumer for interacting performed by the other individual.

5. The method of claim 1, wherein the points are redeemable for any of a good, a service, a discount, cash, an airline point, and other points.

6. The method of claim 1, wherein the compensating based on the ranking includes awarding value to the at least one consumer.

7. The method of claim 1, wherein the compensating based on the ranking includes awarding a debit card to the at least one consumer.

8. The method of claim 1, wherein the compensating based on the ranking includes awarding a stock to the at least one consumer.

9. The method of claim 8, wherein the stock represents ownership in a company.

10. The method of claim 9, wherein the company is engaged in natural resource discovery.

11. The method of claim 10, wherein the natural resource discovery is gold mining.

12. A method of advertising, the method comprising the steps of:
accepting an advertiser, the advertiser having an advertisement;
accepting at least one consumer, the at least one consumer having any of an email account and a physical mail box location;
providing the advertisement to the at least one consumer through any of the email account and the physical mail box;
awarding points to the at least one consumer for interacting with the advertisement;
tracking the awarded points for each of the at least one consumer;
ranking the awarded points for each of the at least one consumer;
compensating at least one of the at least one consumer based on the ranking.

13. The method of claim 12, wherein the interacting includes any of viewing the advertisement, requesting more information on the advertisement, contacting the advertiser, purchasing from the advertiser, and forwarding the advertisement to another individual.

14. The method of claim 12, further comprising awarding points to the at least one consumer for recommending the website to another individual.

15. The method of claim 14, further comprising awarding points to the at least one consumer for interacting performed by the other individual.

16. The method of claim 12, wherein the points are redeemable for any of a good, a service, a discount, cash, an airline point, and other points.

17. The method of claim 12, wherein the compensating based on the ranking includes awarding value to the at least one consumer.

18. The method of claim 12, wherein the compensating based on the ranking includes awarding a stock to the at least one consumer, the stock representing ownership in a company, the company being engaged in natural resource discovery.

19. A method of advertising, the method comprising the steps of:
accepting an advertiser, the advertiser having an advertisement;
accepting at least one consumer, the at least one consumer having a physical address and an email address;
sending the advertisement to the at least one consumer based on their physical address through their email address;
awarding points to the at least one consumer for interacting with the advertisement;
tracking the awarded points for each of the at least one consumer;
ranking the awarded points for each of the at least one consumer;
compensating at least one of the at least one consumer based on the ranking.
